(19) United States
(12) Patent Application Publication
(10) Pub. No.: US 2026/0109047 A1
(43) Pub. Date: Apr. 23, 2026

(54) ROBOT SYSTEM FOR VEHICLE SKIN ATTACHMENT

(71) Applicants: Hyundai Motor Company, Seoul (KR); Kia Corporation, Seoul (KR)

(72) Inventors: Hyeon Cheol Choi, Hwaseong-Si (KR); In Jun Kim, Hwaseong-Si (KR); Byung Yoon Kim, Hwaseong-Si (KR)

(21) Appl. No.: 19/257,068

(22) Filed: Jul. 1, 2025

(30) Foreign Application Priority Data
Oct. 18, 2024 (KR) 10-2024-0143219

(51) Int. Cl. B25J 11/00; B25J 15/06

(52) U.S. Cl. CPC B25J 11/008; B25J 15/0683

(57) ABSTRACT

A skin attachment system includes a robot body, a skin adsorption unit coupled to a first end of the robot body, and an application unit coupled to a second end of the robot body, where the skin adsorption unit includes at least one guide module, the guide module being coupled to the robot body, and a vacuum module coupled to each of one or more guide modules. The skin attachment system further includes a controller configured to vary an angle of the vacuum module depending on a curvature value of a panel of the vehicle.

### CROSS-REFERENCE TO RELATED APPLICATION

This application claims under 35 U.S.C. § 119(a) the benefit of Korean Patent Application No. 10-2024-0143219, filed on Oct. 18, 2024, the entire contents of which are incorporated herein by reference.

### BACKGROUND

### (a) Technical Field

The present disclosure relates to a robot system for skin attachment during assembly of a vehicle, more particularly, to the robot system configured to enable a skin adsorption unit and an application unit to be integrated with a robot body and to appropriately attach a skin to panel surfaces having various shapes.

### (b) Description of the Related Art

A skin attachment system is mounted on an industrial robot and is applied to the operation of attaching skins having various sizes and shapes to panel surfaces during vehicle assembly. With the development of such a system, there is provided a technique capable of stably attaching skins to surfaces having various shapes by precisely adjusting the attachment angle or position of the skins.

In the existing skin attachment technique, since different facilities and processes are used for the respective stages of work, it may be difficult to attach skins having various shapes and sizes to a panel. Further, in the existing technique, an air-blow method is separately used for skin attachment, which serves to assist attachment depending on the position and shape of the panel.

In the existing skin attachment system, since a sealer application unit and a skin adsorption unit are designed independently, it is required to secure a sufficient installation space. Furthermore, when skin attachment work is performed using a skin having a new size and shape, system facilities need to be additionally changed. In addition, the use of the air-blow method causes deterioration in energy efficiency, generates noise, and increases mechanical wear of work equipment. In consideration of the above-described drawbacks of the existing skin attachment system, the existing technique needs to make improvements in flexibility and efficiency for the surfaces having complex shapes.

Recently, in order to address these problems, research and development has been conducted on a system in which a skin adsorption unit and a sealer application unit are formed to be integrated with a robot body so as to quickly attach skins having various sizes and shapes to a target object.

The above information disclosed in this Background section is only for enhancement of understanding of the background of the disclosure, and therefore it may contain information that does not form the prior art that is already known in this country to a person of ordinary skill in the art.

### SUMMARY

The present disclosure provides a robot system configured to enable a skin adsorption unit and a sealer application unit to be integrated with each other such that skins having various sizes and shapes are stably attached to a panel. Additionally, the present disclosure provides a skin attachment device configured to adjust the angle of the skin adsorption unit so as to efficiently attach a skin to a panel having a curved shape. Accordingly, it is possible not only to simultaneously realize space saving and improvement in work efficiency without separately performing additional processes, but also to reduce energy consumption and noise as compared with a conventional air-blow method.

The objects of the present disclosure are not limited to the above-mentioned objects, and other technical objects not mentioned herein will be clearly understood by the following description and will be more clearly understood by embodiments of the present disclosure. Additionally, the objects of the present disclosure may be realized by means indicated in the scope of the claims and combinations thereof.

In one aspect, the present disclosure provides a skin attachment system for attaching a skin to a vehicle including: a robot body; a skin adsorption unit coupled to a first end of the robot body; and an application unit coupled to a second end of the robot body, where the skin adsorption unit includes: at least one guide module, the guide module being coupled to the robot body; and a vacuum module coupled to the guide module, the skin attachment system further including a controller configured to vary an angle of the vacuum module depending on a curvature value of a panel of the vehicle.

In another aspect, the present disclosure provides a skin attachment system including a robot body, a skin adsorption unit coupled to one end of the robot body, and an application unit coupled to the other end of the robot body, wherein the skin adsorption unit includes a plurality of cylinder modules, each of the cylinder modules having one end coupled to the robot body, and a vacuum module coupled to the other end of each of the cylinder modules, the skin attachment system further including a controller configured to vary an angle of the vacuum module depending on a curvature value of a panel.

In a preferred embodiment, the vacuum module may include a vacuum manifold coupled to the guide module, a plurality of vacuum pipes, each of the vacuum pipes having one end coupled to the vacuum manifold, a mounting plate coupled to the other end of each of the vacuum pipes, a plurality of spring plungers located on the mounting plate, each of the spring plungers extending from a corresponding one of the vacuum pipes, a plurality of vacuum pads, each of the vacuum pads being coupled to a corresponding one of the spring plungers, and a plurality of ball joints respectively located between the spring plungers and the vacuum pads.

In another preferred embodiment, the vacuum module may further include a skin detection sensor mounted on an upper surface of the vacuum manifold.

In still another preferred embodiment, the skin attachment system may further include a vacuum generator mounted on the robot body, wherein the vacuum generator may be connected to the vacuum manifold.

In yet another preferred embodiment, each of the vacuum pads may be formed of a wrinkle pad.

In still yet another preferred embodiment, the skin attachment system may further include a skin storage unit configured to provide a skin to the skin adsorption unit, wherein the skin storage unit may include a guide part configured to allow the skin to be loaded therein, a storage located at a lower end of the guide part, a skin plate located between the guide part and the storage, a first position sensor located at a lower end of the skin plate, the first position sensor being disposed to face the skin, and a second position sensor mounted on at least one of opposite upper side surfaces of the guide part.

In a further preferred embodiment, the skin storage unit may further include a ball screw coupled to the skin plate, and a motor coupled to the ball screw and configured to drive the ball screw, wherein the ball screw may move the skin plate upwards or downwards.

In another further preferred embodiment, the controller may be configured to, upon receiving a position signal of the skin from the second position sensor and determining that the skin is not located at a predetermined position of the skin storage unit, control the ball screw such that the skin is located at a set position.

In still another further preferred embodiment, the skin storage unit may further include a moving cylinder located to face the guide part, the moving cylinder being configured to move the guide part along an upper surface of the storage.

In yet another further preferred embodiment, the controller may be configured to, upon receiving information on presence or absence of the skin loaded in the guide part from the first position sensor and determining that the skin in not loaded in the guide part, control the moving cylinder such that the guide part is located at a set position.

In still yet another further preferred embodiment, the controller may be configured to control a vacuum level of each of the vacuum pads according to the curvature value of the panel.

In a still further preferred embodiment, the skin attachment system may further include a image detector configured to inspect an attachment state of the skin attached to the vacuum pads.

In a yet still further preferred embodiment, the controller may be configured to adjust a length of each of the spring plungers according to the curvature value of the panel.

In a further aspect, the present disclosure provides a vehicle skin attachment assembly including a robot; and the skin attachment system for attaching a skin to the vehicle.

In yet a further aspect, the present disclosure provides a skin attachment control method including determining, by a controller, whether a skin storage unit is in a normal state, determining, by the controller, whether a skin adsorption unit is in a normal state when the skin storage unit is in the normal state, applying, by the controller, a sealer to a jig when the skin adsorption unit is in the normal state, attaching, by the controller, a skin corresponding to a position of the applied sealer, and monitoring, by the controller, whether the skin is attached to a correct position of the sealer.

In a preferred embodiment, determining, by the controller, whether the skin storage unit is in the normal state may include receiving, by the controller, information on presence or absence of the skin in the skin storage unit from a first position sensor and determining, by the controller, whether the skin is loaded in the skin storage unit, and receiving, by the controller, information on whether the skin is present at a predetermined position of the skin storage unit from a second position sensor when the skin is loaded in the skin storage unit and determining, by the controller, whether the skin is located in the predetermined position of the storage unit.

In another preferred embodiment, determining, by the controller, whether the skin adsorption unit is in the normal state when the skin storage unit is in the normal state may include adsorbing the skin to the skin adsorption unit, and receiving, by the controller, a skin position from a skin detection sensor when the skin is adsorbed to the skin adsorption unit, determining, by the controller, whether the skin is adsorbed to a predetermined position of the skin adsorption unit, receiving, by the controller, a vacuum level of a vacuum manifold from a vacuum measurement sensor, and determining, by the controller, whether the vacuum level is equal to or higher than a set vacuum level.

In still another preferred embodiment, determining, by the controller, whether the skin is located in the predetermined position of the storage unit may include moving, by the controller, a plate upwards when the skin is out of the predetermined position of the storage unit, determining, by the controller, whether a height of the plate is equal to or higher than a set reference value after the plate is moved upwards, and issuing a skin replenishment notification when the height of the plate is equal to or higher than the set reference value in the determination of whether the height of the plate is equal to or higher than the set reference value.

In yet another preferred embodiment, applying, by the controller, the sealer to the jig when the skin adsorption unit is in the normal state may include moving, by the controller, an application unit to the jig, and applying the sealer corresponding to a position set in the controller.

In still yet another preferred embodiment, attaching, by the controller, the skin corresponding to the position of the applied sealer may include receiving, by the controller, the position of the applied sealer from a camera sensor and moving, by the controller, the skin adsorption unit corresponding to the position of the applied sealer, receiving, by the controller, the position of the applied sealer from the camera sensor and determining, by the controller, whether the skin adsorption unit is located above the applied sealer, releasing, by the controller, vacuum of the skin adsorption unit when the skin adsorption unit is located above the sealer and attaching, by the controller, the skin to the applied sealer, and attaching, by the controller, the skin to the applied sealer and moving, by the controller, the skin adsorption unit to an original position thereof.

In a further preferred embodiment, receiving, by the controller, the position of the applied sealer from the camera sensor and determining, by the controller, whether the skin adsorption unit is located above the applied sealer may include relocating, by the controller, the skin adsorption unit above the applied sealer when the skin adsorption unit is not located above the applied sealer.

In another further preferred embodiment, receiving, by the controller, the information on the presence or absence of the skin in the skin storage unit from the first position sensor and determining, by the controller, whether the skin is loaded in the skin storage unit may include issuing, by the controller, a skin replenishment notification when the skin is not loaded in the skin storage unit, driving, by the controller, a moving cylinder to move a guide part along an upper surface of a storage when the skin replenishment notification is issued, loading, by the controller, the skin in the guide part when the guide part is moved by the moving cylinder, and moving, by the controller, the guide part to an original position of the guide part when the skin is loaded in the guide part.

Other aspects and preferred embodiments of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view of a skin attachment system according to an embodiment of the present disclosure;

FIG. 2A is a perspective view of a vacuum module according to the embodiment of the present disclosure;

FIG. 2B is a perspective view of a skin attachment step according to the embodiment of the present disclosure;

FIG. 3A is a perspective view of a skin storage unit according to the embodiment of the present disclosure;

FIG. 3B is a perspective view of a sensing method of a first position sensor and a second position sensor according to the embodiment of the present disclosure;

FIG. 4 is a schematic flowchart of a skin attachment control method according to the embodiment of the present disclosure; and

FIG. 5 is a specific flowchart of the skin attachment control method according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, reference will be made in detail to various embodiments of the present disclosure, examples of which are illustrated in the accompanying drawings and described below. While the disclosure will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents, and other embodiments, which may be included within the spirit and scope of the disclosure as defined by the appended claims. The present embodiments are provided to more fully explain the disclosure to those of ordinary knowledge in the art.

The terms used in the specification are merely used to describe specific embodiments and are not intended to limit the embodiments. Singular forms are intended to include plural forms as well, unless the context clearly indicates otherwise.

A controller 500 may be implemented by an algorithm configured to control the operation of various components disposed in a vehicle, a memory configured to store data about a program that reproduces the algorithm, and a processor configured to perform the above-described operation using data stored in the memory. In this case, the memory and the processor may be implemented as separate chips. Alternatively, the memory and the processor may be implemented as a single chip. For example, the controller 500 may include at least two of an electronic control unit (ECU), a central processing unit (CPU), a microprocessor unit (MPU), a microcontroller unit (MCU), an application processor (AP), or any type of processor well known in the technical field of the present disclosure.

Furthermore, the controller 500 may be formed of a combination of software and hardware capable of performing a calculation on at least two applications or programs for executing a method according to embodiments of the present invention.

Hereinafter, embodiments will be described in detail with reference to the accompanying drawings. In describing the embodiments with reference to the accompanying drawings, the same or corresponding components will be denoted by the same reference numerals and redundant description thereof will be omitted.

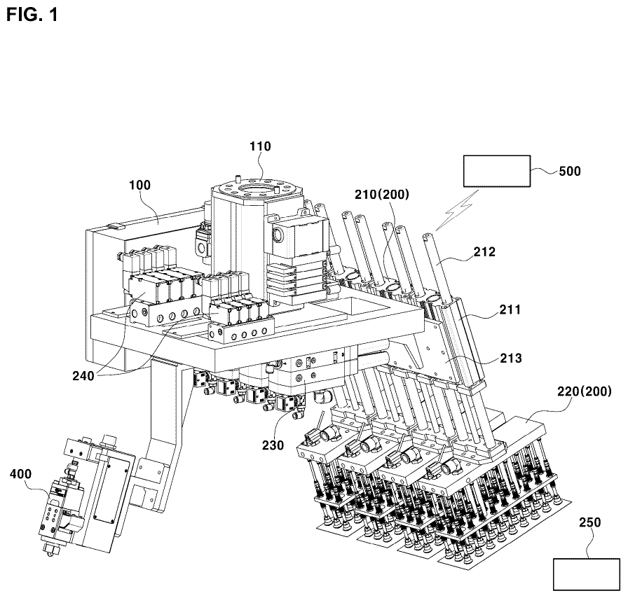

FIG. 1 is a perspective view of a skin attachment system.

According to an embodiment of the present disclosure, the skin attachment system is formed of a robot body 100, a skin adsorption unit 200 mounted on one side of the robot body 100, an application unit 400 mounted on the other side of the robot body 100, and a skin storage unit 300 configured to load skins therein.

The robot body 100 includes a robot arm mounting 110 disposed at the upper end thereof and configured to allow a robot arm (not shown) to be mounted thereon, and the skin adsorption unit is mounted to one side of the robot body 100, and the application unit 400 is mounted on the other side of the robot body 100. Furthermore, the robot body 100 is movable upwards, downwards, leftwards, and rightwards, or rotates in place, through the robot arm (not shown) mounted on the robot arm mounting 110.

The skin adsorption unit 200 includes at least one guide module 210 (e.g., one or more guide modules 210) mounted on one side of the robot body 100 and a vacuum module 220 mounted on one end of the guide module 210. The vacuum module 220 may be configured to correspond to the number of guide modules 210.

Moreover, the skin adsorption unit 200 adsorbs skins by allowing the guide module 210 to be operated in conjunction with the vacuum module 220, and the number of guide modules 210 and vacuum modules 220 to be used may vary depending on the shape of the skin. For example, the skin having a width of 100 mm and a height of 300 mm may be adsorbed by one vacuum module 220, and the skin having a width of 200 mm and a height of 300 mm may be adsorbed by two vacuum modules 220. As described above, the number of guide modules 210 and the vacuum modules 220 to be used may vary depending on the size and shape of the skin.

In addition, according to another embodiment of the present disclosure, skins having various sizes may be adsorbed by adjusting the ratio of the width to the height of the vacuum module 220 or adding the guide module 210 according to the subdivision of the vacuum module 220. For example, when the width of one vacuum module 220 is 100 mm and the height thereof is 300 mm, the one vacuum module 220 may be divided into three vacuum modules 220 each having a width of 100 mm and a height of 100 mm. In addition, the guide modules 210 are added in response to the number of subdivided vacuum modules 220, and the subdivided vacuum modules 220 may be coupled to the added guide modules 210. Accordingly, it is possible to adsorb the skins having various sizes and shape through such a structural modification.

Among the configurations of the skin adsorption unit 200, the guide module 210 is formed of a plurality of cylinders 211, and the cylinders 211 are fixed to one side of a base plate 213. The other side of the base plate 213 is coupled to the robot body 100, thereby enabling the cylinder 211 and the robot body 100 to be formed as an integrated structure. Through this structural configuration, a plurality of cylinders 211 may be integrally moved with the robot body 100.

In addition, the cylinder 211 is formed of a cylinder tube 214 serving as a main body, a piston (not shown) performing piston movement inside the cylinder tube 214, and a piston rod 212 configured to be movable upwards and downwards by receiving force from the piston (not shown). Furthermore, the piston rod 212 is coupled to the upper end of the vacuum module 220. Accordingly, the piston rod 212 may move the vacuum module 220 upwards and downwards according to reciprocating motion of the piston (not shown). The reciprocating motion of the piston (not shown) may be performed by allowing pneumatic pressure or hydraulic pressure to be introduced into a pneumatic port or a hydraulic port of the cylinder 211. Additionally, the introduction of pneumatic pressure or hydraulic pressure may be controlled by the operation of a solenoid valve 240 located on the upper surface of the robot body 100.

In addition, one or more cylinders 211 are coupled to the vacuum module 220, and the cylinders 211 are configured to guide the vacuum module 220 in the longitudinal direction.

The vacuum module 220 coupled to the cylinder 211 is formed of a vacuum manifold 221 coupled to one end of the piston rod 212 and a plurality of vacuum pipes 222 coupled to the rear surface of the vacuum manifold 221. Further, the vacuum module 220 is formed of a mounting plate 223 coupled to one end of the vacuum pipe 222, a plurality of spring plungers 224 located on the rear surface of the mounting plate 223, and a plurality of vacuum pads 225 each coupled to a corresponding one of the spring plungers 224.

The vacuum manifold 221 mounted on the piston rod 212 may be fluidly connected to a vacuum generator 230 located on the rear surface of the robot body 100 through a vacuum hose (not shown). Therefore, the vacuum generator 230 maintains the inside of the vacuum manifold 221 in a vacuum state and controls a vacuum level of the vacuum manifold, as necessary. Here, the vacuum level means pressure relatively lower than atmospheric pressure, and preferably, the internal pressure of the vacuum module 220. In addition, as the vacuum level at the inside of the vacuum module 220 decreases, suction pressure becomes higher, thereby increasing adhesion of the skin to the vacuum module 220.

One end of each of the plurality of vacuum pipes 222 is connected to the rear surface of the vacuum manifold 221. Moreover, each of the vacuum pipes 222 is configured to extend in a direction perpendicular to the rear surface of the vacuum manifold 221. Therefore, each of the vacuum pipes 222 is fluidly connected to the vacuum manifold 221, thereby maintaining the same vacuum state as that of the vacuum manifold 221.

Furthermore, one end of each of the vacuum pipe 222 is coupled to the mounting plate 223. The mounting plate 223 may be located to be parallel with the vacuum manifold 221. That is, a plurality of vacuum pipes is configured such that one end of each of the vacuum pipes is connected to the mounting plate 223 and the other end thereof is connected to the vacuum manifold 221 between the mounting plate 223 and the vacuum manifold 221.

A plurality of spring plungers 224 is connected to the rear surface of the mounting plate 223. The plurality of spring plungers 224 may be formed to extend from the respective vacuum pipes 222. Preferably, the vacuum pipe 222 may extend from the vacuum manifold 221 and may pass through the mounting plate 223. In addition, the number of spring plungers 224 may correspond to the number of the vacuum pipes 222. Moreover, the plurality of spring plungers 224 may be configured to compensate for a depth corresponding to the panel shape by adjusting the length of each of the spring plungers 224 differently depending on the shape of the panel.

In addition, the vacuum pad 225 is located at one end of each of the spring plungers 224. The surface of skin is bonded to one end of the vacuum pad 225, and the vacuum pad 225 is configured to adsorb the skin from the skin storage unit 300.

Furthermore, the vacuum pad 225 may be formed of a wrinkle pad. Moreover, the wrinkle pad has a plurality of wrinkles and is designed to fold or unfold the wrinkles when the skin is attached to the panel surface. In this manner, the wrinkle pad may attach the skin to the panel surface along the curved shape of the panel surface. Moreover, the number of vacuum pads 225 is configured to correspond to the number of spring plungers 224.

A ball joint 228 is located between the spring plunger 224 and the vacuum pad 225. The ball joint 228 may be configured as a four-way ball joint 228 and may be configured to move the vacuum pad 225 vertically and horizontally or to rotate the same.

The skin storage unit 300 configured to provide the skin to the vacuum pad 225 is formed of a guide part 310 in which the skin is loaded and a storage 320 located to face the lower end of the guide part 310. Further, the skin storage unit 300 is formed of a skin plate 330 located between the guide part 310 and the storage 320, a moving cylinder 380 located on the upper surface of the storage 320, a first position sensor 340 located at the lower end of the skin plate 330, and a second position sensor 350 located on both sides of the upper end of the guide part 310.

The storage 320 is formed to have a rectangular parallelepiped case shape. A loading space may be formed inside the storage 320. Here, a ball screw 360 configured to move the skin plate 330 upwards and downwards and a motor 370 configured to drive the ball screw 360 are built in the storage 320.

The guide part 310 is formed to have a rectangular parallelepiped structure, and the upper and lower portions thereof are open. Preferably, the guide part 310 may have a configuration in which one surface on which the skin is stacked is open. Through this structural configuration, an operator may check the amount of the skin stacked in the guide part 310 from the outside.

At least two sensors are arranged on the upper portion of the guide part 310 to determine the correct position of the skin in the guide part 310. The at least two sensors refer to the second position sensors 350, and each of the second position sensors 350 is configured to detect the position of the skin and determine whether the skin is placed at a set position.

The second position sensor 350 may be an optical sensor, an ultrasonic sensor, or a proximity sensor. Preferably, the second position sensor 350 may be configured as a reflective photo sensor or a transmissive photo sensor among optical sensors. The optical sensor is formed of a light emitting part and a light receiving part, and detects a signal change when the skin blocks or reflects light.

In addition, according to an embodiment of the present disclosure, the second position sensor 350 may be configured as an ultrasonic distance sensor among ultrasonic sensors. The ultrasonic sensor emits sound waves, receives sound waves reflected from the skin, and detects the position of the skin by a change in reflection time.

Furthermore, the second position sensor 350 may be configured as an inductive proximity sensor or an electrostatic proximity sensor among proximity sensors. The proximity sensor detects, by using an electromagnetic wave, a change in magnetic fields when the skin approaches the proximity sensor.

A controller 500 of the present disclosure receives the skin position from each of the second position sensors 350 and determines whether the skin is located at the correct position within the guide part 310. When the skin is not located at the correct position within the guide part 310, the controller 500 raises the skin plate 330 located between the guide part 310 and the storage 320 so as to place the skin at the correct position.

In addition, the controller 500 receives the skin position from each of the second position sensors 350 and determines whether the skin is located at the correct position, and raises the skin plate 330 until the skin is determined to be in the correct position. Through this operation, the skin is moved to the upper portion of the guide part 310 and is loaded on the vacuum module 220 at the predetermined position.

When the skin is loaded by the vacuum module 220 and all of the skins loaded in the guide part 310 are completely exhausted, the first position sensor 340 located at the lower end of the skin plate 330 issues a skin replenishment notification. The first position sensor 340 may be configured as an ultrasonic sensor. The first position sensor 340 transmits an ultrasonic signal to the skin, the surface of which contacts the skin plate 330, and receives an ultrasonic wave reflected by the skin to determine whether the skin is present in the guide part. When the first position sensor 340 transmits an ultrasonic signal to the skin but does not receive the ultrasonic wave reflected by the skin, the controller determines that the skin is not loaded in the guide part 310.

That is, the first position sensor 340 measures the presence or absence of the skin in the guide part 310. Similarly to the second position sensor 350, the first position sensor 340 may be configured as an optical sensor, an ultrasonic sensor, or a proximity sensor.

When the skin replenishment notification is issued, the controller 500 drives the moving cylinder 380 located on the upper end of the storage 320 to move the guide part 310 to a predetermined position. The moving cylinder 380 is located facing the other end surface of the guide part 310. Therefore, when a movement signal for the guide part 310 is applied to the moving cylinder 380, the moving cylinder 380 applies force to the other end surface of the guide part 310. Accordingly, the guide part 310 is moved along the upper surface of the storage 320. The guide part 310 is placed at a replenishment position set by the controller 500 on the upper surface of the storage 320. At the replenishment position, the skin is replenished in the guide part 310, and the replenished skin is provided to the vacuum pad 225.

The present disclosure is configured to include an image detector 250 to check, when the skin is adsorbed on the vacuum pad 225, whether the skin is accurately attached to the predetermined position of the vacuum pad 225. The image detector 250 is formed of a camera and image processing software and is configured to collect image data by photographing the upper portion and peripheral parts of the skin in a standby state after the skin is loaded.

In addition, when the skin is attached to the correct position of the vacuum pad 225, the controller 500 applies a sealer to the inside of the panel through the application unit 400.

The application unit 400 is attached to the other side of the robot body 100. Preferably, the application unit 400 is configured to be coupled to the robot body 100 so as to be movable in the upward-and-downward direction.

Additionally, the application unit 400 moves on the panel according to the set position stored in the controller 500. Through this configuration, the application unit 400 applies the sealer over the set position stored in the controller 500. Furthermore, the controller 500 controls the movement path and position of the application unit 400 such that the sealer is uniformly applied to at least one area according to the set position of the panel.

Additionally, when the skin adsorbed on the vacuum pad 225 is attached to the panel, the controller 500 may adjust the angle of the vacuum pad 225 in response to a curvature value according to the shape of the panel of the vehicle. The angle of the vacuum pad 225 means an angle between a line extending from the vacuum pipe 222 and the surface of the panel, which contacts the surface of the skin.

The present disclosure may be configured to detect whether the skin is adsorbed on the vacuum pad 225 and a curvature of the panel by utilizing a detection sensor 226 located on the upper side of the vacuum manifold 221. In another embodiment of the present disclosure, the detection sensor 226 may be mounted on the lower end of the mounting plate 223 or on the vacuum pad 225. In this manner, the detection sensor 226 may be mounted in various positions and is not limited to the embodiment described in the specification.

The detection sensor 226 measures the curvature of the panel in real time and transmits a curvature value of the panel to the controller 500. Furthermore, the detection sensor 226 may use various types of sensors. Preferably, the detection sensor 226 may use a contact sensor, a non-contact distance sensor, and a laser scanner.

The contact sensor detects the curvature of the panel by directly touching the panel surface. The contact sensor changes the angle depending on the position at which the contact sensor is in contact with the panel. The controller 500 calculates the curvature value of the panel based on an information value according to a change in angle. Such a contact sensor provides an accurate measurement value based on mechanical movement.

The non-contact distance sensor measures a distance to the panel surface using ultrasonic or infrared rays. The non-contact sensor collects information on a distance to the panel surface, and the controller 500 determines the curvature shape of the panel in real time through this information.

The laser scanner quickly scans the entire shape of the panel. The laser scanner collects distance data at multiple points of the panel, and the controller 500 receives the distance data.

In addition, the controller 500 calculates a necessary angle adjustment value based on curvature data received from the detection sensor 226.

When angle adjustment is required, the controller 500 rotates the vacuum pad 225 upwards, downwards, leftwards, and rightwards through the ball joint 228 located on the upper end of the vacuum pad 225, changes the structure of the vacuum pad 225, or individually adjusts the vacuum level of a plurality of vacuum pipes 222.

According to the embodiment of the present disclosure, the controller 500 adjusts the angle of the vacuum pad 225 by varying the angle of the vacuum pad 225 through the ball joint 228 with reference to the calculated angle adjustment value. In addition, the controller 500 individually adjusts the vacuum level of each vacuum pipe 222 in response to the curvature value of the panel, thereby allowing the vacuum pad 225 to stably adsorb the skin and allowing the skin to adhere to the curved panel surface.

For example, in an area where the curvature value of the panel is large, the controller 500 increases the vacuum level of the vacuum pipe 222 so as to allow the vacuum pad 225 to adhere to the curved portion of the skin. The vacuum pad 225 having a high vacuum level increases the adhesion of the skin, and as a result, even if the skin is attached to an area of the panel having a large curvature value, the skin is not detached from the vacuum pad but adheres to the vacuum pad 225. In this manner, the skin is stably placed on the curved surface of the panel. In other words, the high vacuum level of the vacuum pipe enables the skin to stably adhere to the curved surface of the panel.

As another example, when a part of the panel has a small curvature value or the panel has a flat surface, the controller 500 adjusts the vacuum level of the vacuum pipe 222 such that the vacuum pad 225 causes the skin to adhere to a flat portion of the panel. In this case, the vacuum pipe 222 lowers the vacuum level thereof so as to allow the skin to horizontally adhere to the flat surface of the panel, and the angle of the vacuum pad is adjusted such that the vacuum pad appropriately adheres to the panel surface.

Furthermore, when fine angle adjustment of the vacuum pad is additionally required after the angle adjustment of the vacuum pad is performed through the ball joint 228 and vacuum level control, the controller 500 may adjust the angle of the vacuum pad 225 by unfolding or folding the wrinkles of the vacuum pad 225 with reference to the calculated angle adjustment value.

The wrinkles may be unfolded or folded depending on the curvature of the panel, thereby adjusting the vacuum pad 225 to the shape of the panel. Preferably, when the vacuum pad 225 is operated in conjunction with an actuator (not shown), the controller 500 may control the actuator with reference to the curvature value of the panel so as to determine whether to unfold or fold the wrinkles at a specific position of the panel, thereby adjusting the angle.

Additionally, the controller 500 may perform, in response to the curvature shape of the panel, depth adjustment and angle adjustment in conjunction with the operations of the spring plunger 224, the ball joint 228, and the vacuum pad 225. Moreover, in the case of depth adjustment, the depth is adjusted by moving the ball joint 228 upwards and downwards along with the longitudinal compression of the spring plunger 224.

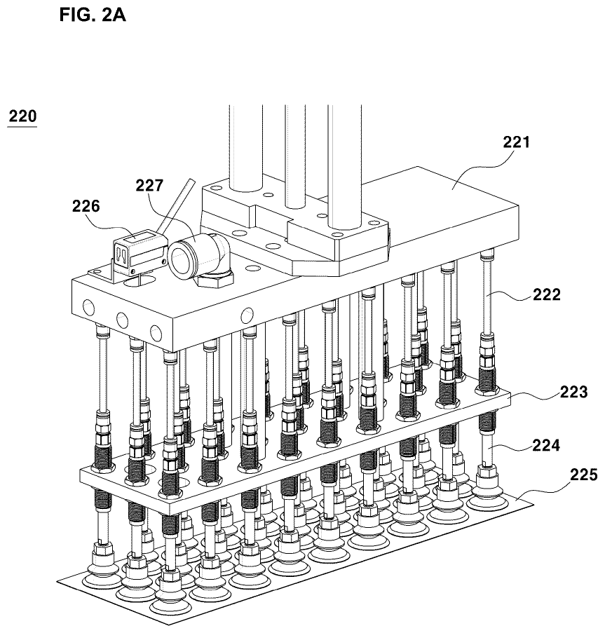

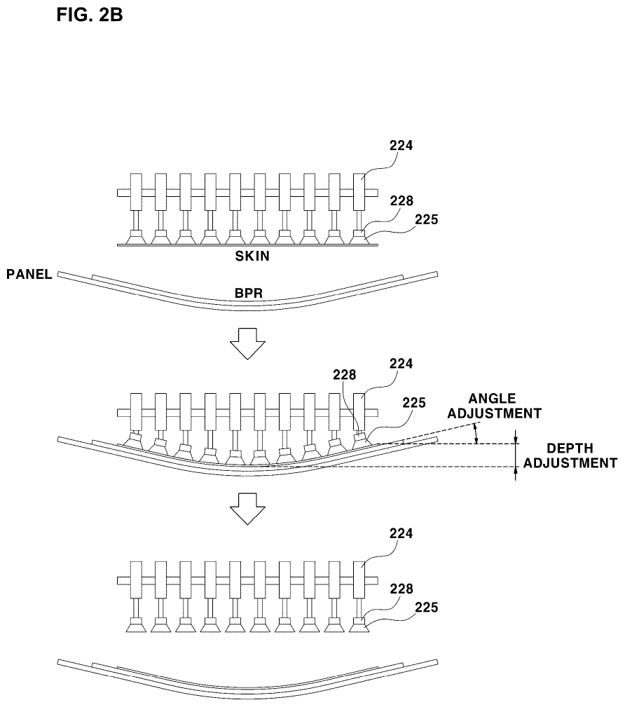

FIG. 2A is a perspective view of the vacuum module 220, and FIG. 2B is a view showing the skin attachment process.

According to the embodiment of the present disclosure, the vacuum module 220 may be moved upwards and downwards by the guide module 210 and may be rotated integrally with rotation of the robot body 100.

In addition, the vacuum module 220 includes the vacuum manifold 221 coupled to the guide module 210 and fluidly connected to the vacuum generator 230 through a vacuum hose (not shown). Preferably, the vacuum hose (not shown) may be connected to a vacuum connector 227 located on the upper surface of the vacuum manifold 221.

Furthermore, the vacuum manifold 221 may be manufactured in the shape of a rectangular parallelepiped, and a plurality of connection ports may be configured on the back surface of the vacuum manifold. The vacuum pipes 222 are respectively connected to the connection ports. Therefore, the vacuum manifold 221 may be configured to be fluidly connected to the plurality of vacuum pipes 222 through the respective connection ports, and to control an air flow inside so as to provide an individual vacuum state to each vacuum pipe 222.

In addition, the vacuum pipe 222 may be located between the vacuum manifold 221 and the mounting plate 223 so as to fluidly connect the vacuum manifold 221 to the mounting plate 223. Furthermore, a plurality of vacuum pipes 222 may be located between the vacuum manifold 221 and the mounting plate 223 with a predetermined interval therebetween, and the vacuum pipes 222 may extend in a state of being perpendicular to the upper surface of the mounting plate 223. In particular, each vacuum pipe 222 may independently maintain the vacuum state thereof such that the vacuum may be selectively applied only to a necessary portion depending on the curvature of the panel shape. Each vacuum pipe 222 can also be individually controlled to maintain specific vacuum levels, ensuring optimal adhesion based on varying panel curvatures.

The mounting plate 223 includes a plurality of holes for fixation of the plurality of vacuum pipes 222. Through this configuration, the vacuum pipes 222 may be formed to be integrated with the mounting plate 223. The vacuum pipes 222 may be located by respectively penetrating a plurality of holes formed in the mounting plate 223.

The spring plunger 224 extending from the vacuum pipe 222 is coupled to the lower end of the mounting plate 223.

The spring plunger 224 according to the present disclosure is configured to adjust the position and adhesion of the vacuum pad 225 so as to uniformly attach the skin to the panel surface.

The spring plunger 224 is formed of an external housing and a coil spring disposed at the inside of the housing (not shown in the drawing), and a pad mounting bracket capable of fixing the vacuum pad 225 is connected to the lower end of the spring plunger 224. The coil spring is located inside the plunger housing, and when the vacuum pad 225 comes into contact with the panel surface, the housing is compressed to generate elastic force.

The spring plunger 224 is configured to be able to respond to various panel shapes by adjusting the length and strength of the coil spring. In the flat section of the panel, the spring plunger 224 provides minimum elastic force such that the vacuum pad 225 appropriately adheres to the panel. On the other hand, in response to a panel shape having a large curvature, the coil spring is compressed and the vacuum pad 225 is adjusted so as to be appropriately located on the panel surface.

Furthermore, the spring plunger 224 may include a coil spring having a multilayer structure. Through this structural configuration, it is possible to provide a multi-functional elastic effect through which the spring strength may be gradually increased so as to respond to various curvatures and a constant pressure may be maintained.

That is, in the present disclosure, depth adjustment of the vacuum pad 225 may be appropriately performed through the spring plunger 224 for a depth difference generated depending on the curvature value of the panel shape.

As shown in FIG. 2B, when the skin is attached to the panel, the present disclosure is configured to adjust the depth and angle of the vacuum pad 225 depending on the curvature value of the panel shape.

The vacuum pad 225 is configured to be adjusted in height through the spring plunger 224. Preferably, the height of the vacuum pad means a vertical distance from the lowest end of the panel shape.

For example, in the case of a panel having a shape in which the inner side of the panel includes a flat surface and an inclined surface, the height of which gradually increases toward both ends of the flat surface, the coil spring of the spring plunger 224 located at a panel portion having a large curvature is more compressed than the coil spring of the spring plunger 224 located at a panel portion having a small curvature. In this case, the length of the spring plunger 224 is reduced, and the vacuum pad 225 facing the panel portion having a large curvature may be located higher than the vacuum pad 225 facing the lowest end of the panel.

On the other hand, the spring plunger connected to the vacuum pad 225 facing the flat surface of the panel is stretched longer than the spring plunger connected to the vacuum pad 225 facing the panel portion having a large curvature. Therefore, the vacuum pad 225 facing the flat surface of the panel is located lower than the vacuum pad 225 facing the panel portion having a large curvature.

As another example, in the case of a panel having a shape in which the inner side of the panel includes a flat surface and an inclined surface, the height of which gradually decreases toward both ends of the flat surface, the coil spring of the spring plunger located on the flat surface of the panel is compressed more than the coil spring of the spring plunger located on a panel portion having a large curvature. In this case, the length of the spring plunger located on the flat surface of the panel becomes shorter than the length of the spring plunger located on the panel portion having a large curvature. Through this configuration, the height of the vacuum pad 225 located on the flat surface of the panel has a larger value than that of the height of the vacuum pad 225 facing the panel portion having a large curvature.

In contrast, the length of the spring plunger 224 facing the panel portion having a large curvature becomes larger than the length of the spring plunger 224 facing the flat surface of the panel. Therefore, the vacuum pad 225 facing the panel portion having a large curvature is located at a lower position than that of the vacuum pad 225 facing the flat surface of the panel.

The angle adjustment is configured such that, when the skin is attached to the panel, the vacuum pad 225 including a wrinkle pad is adjusted to an inclination of the panel. The wrinkle pad is folded or unfolded in response to a pressure change of the spring plunger 224, thereby adjusting the inclination of the vacuum pad 225.

For example, when the inclination of the panel gradually increases toward one end, wrinkles formed at one end of the vacuum pad 225 are folded, and wrinkles formed at the other end of the vacuum pad 225 are unfolded. Through this configuration, the vacuum pad 225 is formed to be inclined so as to come into close contact with the inclined surface of the panel. Conversely, on the flat portion of the panel, wrinkles formed at one end and the other end of the vacuum pad 225 are equally folded or unfolded. Accordingly, the vacuum pad may maintain the flat state thereof and come into contact with the panel.

In this manner, the vacuum pad 225 is configured to flexibly respond to various inclinations of the panel such that the skin is uniformly attached to the panel surface.

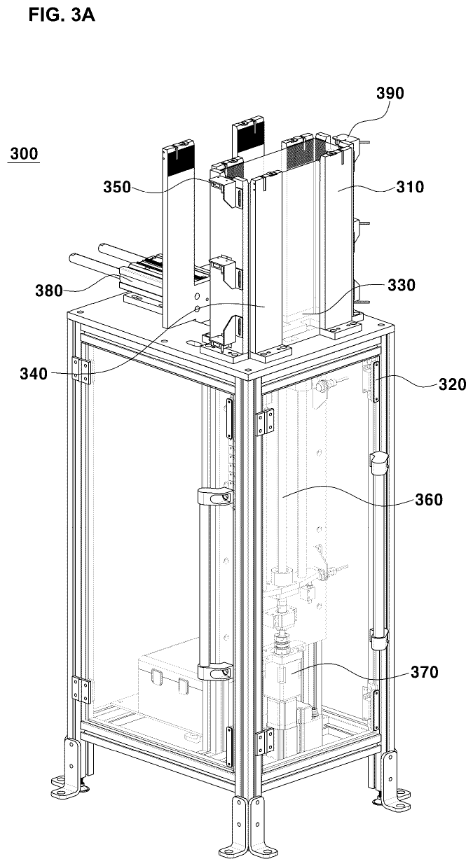

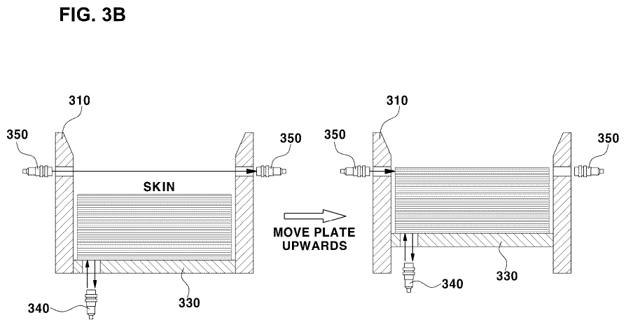

FIG. 3A is a perspective view of the skin storage unit 300, and FIG. 3B is a perspective view of the first position sensor 340 and the second position sensor 350.

According to the embodiment of the present disclosure, the skin storage unit 300 serves to provide the skin to the skin adsorption unit 200.

When the skin adsorption unit 200 loads the skin from the skin storage unit 300, a stopper 390 may be provided on the upper end of the guide part 310 to prevent two or more skins from being adsorbed simultaneously.

The stopper 390 prevents two or more skins from being loaded in the storage unit through the stopper 390 having a hook shape or a roller device. For example, when the hook-shaped stopper 390 is used, the end of the hook stopper 390 is formed to face the inside of the guide part 310 such that only a single skin passes through the hook stopper. The end of the hook stopper 390 is designed to allow the front portion of a single skin to pass while physically blocking any subsequent skins attempting to follow, thus preventing overlap or double feeding.

As another example, when the roller device is used, an upper roller and a lower roller are set to be rotated while allowing a single skin to stably pass therethrough. As the skins pass through the gap between the upper and lower rollers, the rollers apply downward pressure to securely hold and separate each skin, moving them individually to prevent double feeding. Here, when the subsequent skin follows the preceding skin, rotational force of the rollers pushes the subsequent skin out or filters the same, thereby preventing two or more skins from passing through the rollers.

In this manner, the hook-shaped stopper 390 and the roller device control the skins so as to supply the same one by one through their respective structures, thereby enabling the vacuum pad 225 to accurately adsorb a single skin.

The guide part 310 including the stopper 390 is formed as a rectangular parallelepiped structure with the upper and lower portions open, and the inner width and length thereof is adjustable depending on the shape and size of the skin. The inner surface of the guide part 310 is provided with an adjustable rail or an insert member, so the width or the length of the guide part 310 may be adjusted depending on skin shapes having various sizes. Through this configuration, the guide part 310 may load skins having various sizes from small to large skins therein and may prevent the skins from shaking or being placed in the wrong position within the guide part 310.

The moving cylinder 380 located facing the other side of the guide part 310 moves the guide part 310 along the upper surface of the storage 320.

As shown in FIG. 3B, the controller 500 of the present disclosure may receive information indicating whether the skin is present in the guide part 310 through the first position sensor 340. When at least one skin is present in the guide part 310, the controller may determine that the skin is present in the guide part 310.

Furthermore, the controller 500 may receive information on a distance between the first position sensor 340 and the skin through the first position sensor 340. When the distance between the first position sensor 340 and the skin is equal to or greater than a set distance stored in the controller 500, the controller may issue a skin replenishment notification.

When the skin replenishment notification is issued, the controller 500 drives the moving cylinder 380 so as to move the guide part 310 to the set position stored in the controller 500. Through this configuration, a worker conveniently replenish the skins, and the operation may be automatically performed by a robot. Preferably, the controller 500 may perform skin replenishment when the guide part 310 is located at the replenishment position stored in the controller 500.

The motor 370 configured to control upward-and-downward movement of the skin plate 330 located between the guide part 310 and the storage 320 is disposed inside the storage 320, and a stepper motor may be used as the motor. The stepper motor is a motor configured to convert electrical signals stepwise such that the motor is rotated at a constant angle, thereby enabling accurate position control.

One end of the ball screw 360 is connected to the motor 370, and the other end of the ball screw 360 is connected to the skin plate 330. Therefore, when the motor 370 is driven, the ball screw 360, one end of which is connected to the motor 370, is rotated, and the skin plate 330 is moved upwards through rotation of the ball screw 360. That is, the stepper motor 370 applies driving force to the skin plate 330 such that the skin is located at the correct position within the guide part 310.

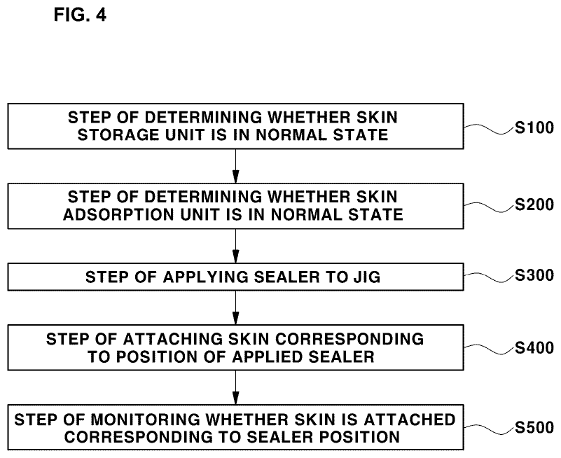

FIG. 4 is a schematic flowchart of a skin attachment control method.

According to the embodiment of the present disclosure, in the skin attachment control method, the controller 500 determines whether the skin storage unit 300 is in a normal state (S100), determines whether the skin adsorption unit 200 is in a normal state (S200), and applies a sealer corresponding to a set position stored in the controller 500 (S300). Furthermore, after the sealer is applied, a skin is attached to the vacuum pad 225 corresponding to the applied sealer position (S400), and whether the skin is attached to the correct position is monitored (S500). As described above, the series of processes are sequentially performed.

First, in the step (S100) of determining, by the controller 500, whether the skin storage unit 300 is in the normal state, the controller determines whether the skin is placed at a predetermined position inside the guide part 310 and whether the skin is loaded inside the guide part 310. The controller 500 receives information on whether the skin is present in the guide part 310 from the first position sensor 340 and determines whether the skin is loaded in the guide part 310 (S110).

Upon determining that the skin is present in the guide part 310, the controller 500 receives information on the skin position from the second position sensor 350 and determines whether the skin is placed at the correct position in the guide part 310 (S120).

In this case, upon determining that the skin is not located at the correct position of the skin storage unit 300, the controller 500 raises the skin plate 330 so as to place the skin at the correct position in the skin storage unit 300. Preferably, the controller 500 applies power to the motor 370 so as to move the skin plate 330 upwards (S130).

When the skin plate 330 is moved to the set height, the controller 500 receives, from the first position sensor 340, a measurement value regarding a vertical distance between the first position sensor 340 and the skin facing the first position sensor 340. Through this step, the controller 500 may calculate a height value of the skin plate 330.

Furthermore, the controller 500 determines whether the calculated height value of the skin plate 330 exceeds a set height value stored in the controller 500 (S140). When the skin plate 330 exceeds the set height value stored in the controller 500, the controller 500 determines that skin replenishment is necessary and issues a skin replenishment notification (S150).

Such a notification may be displayed on a display. Additionally, after the skin replenishment notification is issued, the controller 500 moves the guide part 310 to a replenishment position stored on the upper surface of the storage 320 through the moving cylinder 380 (S160).

The controller 500 determines whether the guide part 310 has moved to the replenishment position stored on the upper surface of the storage 320 through a camera sensor. At this time, when the guide part 310 has moved to the replenishment position stored on the upper surface of the storage 320, the controller 500 replenishes the skin into the guide part 310 through a skin replenishment unit (not shown) (S170). After skin replenishment is completed, the controller 500 moves the guide part 310 to the original position thereof through the moving cylinder 380 (S180). In this manner, when the skin replenishment notification is issued, skin replenishment steps are sequentially performed.

In the step of determining whether the skin is loaded in the guide part 310, upon determining that the skin is not loaded in the guide part 310, the controller 500 issues the skin replenishment notification (S150). After the skin replenishment notification is issued, the controller 500 moves the guide part 310 to the position set at the upper end of the storage for skin replenishment (S160) and replenishes the skin in the guide part 310 by the amount set in the controller 500 (S170). After the skin replenishment is completed, the controller 500 returns the guide part 310 to the original position thereof (S180).

When the skin is present in the skin storage unit and the skin is located at the correct position of the skin storage unit, the controller 500 determines that the skin storage unit 300 is in the normal state. Upon determining that the skin storage unit 300 is in the normal state, the controller 500 determines whether the skin adsorption unit 200 is in the normal state (S200).

In the step of determining whether the skin adsorption unit 200 is in the normal state, the controller 500 moves the robot body 100 to a position corresponding to the position of the skin storage unit 300. At this time, the skin adsorption unit 200 is moved integrally with the robot body 100 and is moved above the skin storage unit 300. Preferably, the vacuum pad 225 of the vacuum module 220 is located to face the upper portion of the skin storage unit 300.

In this case, the controller 500 lowers the vacuum module 220 through the guide module 210 connected to the vacuum module 220 located on the upper portion of the skin. When the vacuum module 220 is lowered, the skin is attached to the vacuum pad 225 of the vacuum module 220 (S210).

After the skin is adsorbed to the vacuum pad 225, the controller 500 determines whether the skin is attached to the predetermined position of the skin adsorption unit 200 through the image detector 250. Specifically, the controller 500 analyzes image data collected from the image detector 250 so as to determine whether the skin is inappropriately located or inappropriately loaded.

For example, the controller 500 determines whether the skins are loaded in two layers through edge image processing so as to detect whether two skins are loaded simultaneously. As another example, the controller 500 determines whether the skin is accurately attached to the predetermined position of the vacuum pad 225 through color image processing, and determines whether the skin is correctly located by detecting a specific color area. Through this step, the controller 500 may determine whether the skin is attached to the correct position of the vacuum pad 225.

Simultaneously or sequentially, the controller 500 receives a vacuum level of the vacuum manifold from a vacuum sensor attached to the vacuum manifold and determines whether the vacuum level is equal to or higher than a set vacuum level stored in the controller 500 (S220).

When the skin is not adsorbed to the correct position of the skin adsorption unit 200, the controller 500 generates a skin non-detection notification. Furthermore, when the vacuum level of the vacuum manifold is less than the set vacuum level, the controller 500 generates a vacuum non-generation notification (S230).

The controller 500 determines that the skin adsorption unit 200 is operating normally when the skin is attached to the correct position of the skin adsorption unit 200 and the vacuum level of the vacuum manifold is equal to or higher than the set vacuum level.

When the skin adsorption unit 200 is operating normally, the robot body 100 is moved to a jig, and a step of applying a sealer to the panel is performed (S300).

In the step of applying the sealer to the panel, the controller 500 moves the robot body 100 to the jig and then applies the sealer to the panel corresponding to the application position set in the controller 500 (S310). After applying the sealer to the panel, the controller 500 moves the skin adsorption unit 200 corresponding to the application position set in the controller 500. Preferably, the controller 500 locates the skin adsorption unit 200 above the applied sealer (S320).

After locating the skin adsorption unit 200 above the applied sealer, the controller 500 performs a step of attaching the skin to the applied sealer (S400).

In the skin attachment step, the controller 500 determines whether the skin adsorption unit 200 is located corresponding to the position of the sealer through a camera sensor attached to the robot body 100 or the skin adsorption unit 200 (S410). Here, when the skin adsorption unit 200 is located above the applied sealer, the controller 500 releases the vacuum state of the vacuum pad 225 so as to drop the skin on the applied sealer. Furthermore, the controller 500 presses the skin through the spring plunger 224 such that the skin is stably seated on the panel (S420). After the attachment step is completed, the controller 500 returns the skin adsorption unit 200 to the original position thereof (S430).

However, in the step of determining whether the skin adsorption unit 200 is located corresponding to the position of the sealer, when the skin adsorption unit 200 is out of the correct position of the sealer, the controller 500 relocates the skin adsorption unit 200 to the correct position of the applied sealer (S440). Thereafter, the controller 500 determines again whether the skin adsorption unit is located above the applied sealer. Here, when the skin adsorption unit is located above the applied sealer, the attachment step is performed.

After the attachment step is completed, the controller 500 performs a step of monitoring whether the skin is appropriately attached to the correct position of the applied sealer through the image detector 250 (S500), thereby completing the skin attachment step.

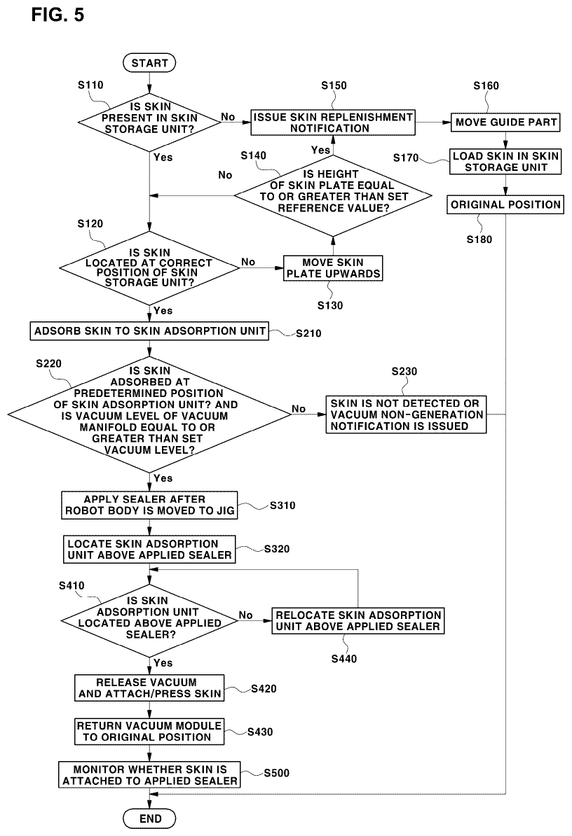

FIG. 5 is a specific flowchart of a skin attachment control method.

According to the embodiment of the present disclosure, in the step of loading the skin in the skin storage unit 300 (S170), the skin replenishment step may further include a step of inspecting a surface state of the skin before the skin is loaded. In the skin surface state inspection step, the controller 500 determines whether there are scratches or foreign substances such as dust on the skin surface through a camera sensor or an optical sensor. Furthermore, upon detecting an abnormality in the skin surface, the controller 500 may automatically exclude defective skin to prevent quality deterioration in subsequent processes.

In addition, in the step of attaching the skin to the skin adsorption unit 200 (S210), the controller 500 may further include a step of checking the vacuum state of the vacuum manifold 221 in advance.

The controller 500 compares a vacuum level shown in the vacuum sensor attached to the vacuum manifold 221 with an initial vacuum level set in the controller 500. When the vacuum level is lower than the initial vacuum level, the controller controls the vacuum generator 230 to adjust or strengthen the vacuum inside the vacuum manifold 221. Through this vacuum state checking step, it is possible to secure a vacuum state in which the skin is stably adsorbed to the vacuum pad.

In addition, in the step of applying the sealer to the panel after the skin is adsorbed to the vacuum pad 225 (S310), the controller 500 may further include a quality inspection step after the sealer is applied to the panel.

The controller 500 receives a sealer application position and a sealer application state from the camera sensor attached to the application unit 400. Depending on the sealer application state, the controller may further perform a process of determining whether the sealer is uniformly applied to the panel and whether a thickness of the distributed sealer coincides with a set thickness stored in the controller 500.

When the sealer is not uniformly applied or when the thickness of the applied sealer does not reach the set thickness stored in the controller 500, the controller 500 generates a control signal to additionally apply or reapply the sealer to the panel. The application unit may additionally perform such an additional application process or a reapplication process. Then, the application unit may return to the original position thereof.

In addition, after the skin attachment step, the monitoring step (S500) may further include a step of monitoring a curing process of the sealer.

The controller 500 may include a step of monitoring the curing state of the sealer through a camera sensor after the sealer is applied to the panel and determining the curing progress of the sealer. Furthermore, the controller 500 measures the temperature state of the sealer through a non-contact temperature sensor during the curing process so as to determine whether the temperature state meets set conditions. Additionally, the controller 500 may adjust the curing time and conditions as necessary to maintain the quality of the sealer.

In summary, according to the present disclosure, the sealer application unit 400 and the skin adsorption unit 200 may be integrally mounted on the robot body 100, and depth adjustment of the vacuum pad 225 and angle adjustment thereof may be performed with reference to a curvature value of the panel shape so as to respond to various panel shapes. In addition, the present disclosure provides a skin attachment control method of attaching a skin to a predetermined position of a panel by sequentially determining whether the skin storage unit 300 and the skin adsorption unit 200 are in the normal state.

As is apparent from the above description, the present disclosure may achieve the following effects by the configuration, combination, and use relationship described in the embodiments.

First, the present disclosure provides a skin attachment system configured to enable a skin adsorption unit and an application unit to be integrated with a robot body. Accordingly, it is not necessary to perform separate equipment installation or additional processes, thereby having an effect of reducing an installation space and simplifying a work process. As a result, manufacturing costs may be reduced, and production efficiency may be improved.

Second, since a skin adsorption unit has a function of changing the angle thereof through a controller, it is possible to attach the skin to panels having various shapes. Through this configuration, the skin may be stably attached to a panel having a curved surface, thereby having an effect of increasing work accuracy and improving product quality.

Third, since a vacuum pad and a spring plunger are used instead of using an air-blow method during skin attachment work, energy consumption and noise generation may be significantly reduced, thereby having an effect of improving a work environment, increasing energy efficiency, and reducing maintenance costs.

The present disclosure has been described in detail with reference to preferred embodiments thereof, and the present disclosure may be used in various other combinations, modifications, and environments. That is, it will be appreciated by those skilled in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A skin attachment system for attaching a skin to a vehicle, the skin attachment system comprising:
a robot body;
a skin adsorption unit coupled to a first end of the robot body; and
an application unit coupled to a second end of the robot body,
wherein the skin adsorption unit comprises:
at least one guide module, the guide module being coupled to the robot body; and
a vacuum module coupled to the guide module,
the skin attachment system further comprising a controller configured to vary an angle of the vacuum module depending on a curvature value of a panel of the vehicle.

2. The skin attachment system of claim 1, wherein the vacuum module comprises:
a vacuum manifold coupled to the guide module;
a plurality of vacuum pipes, each of the vacuum pipes being coupled to the vacuum manifold;
a mounting plate coupled to each of the vacuum pipes;
a plurality of spring plungers located on the mounting plate, each of the spring plungers extending from a corresponding one of the vacuum pipes;
a plurality of vacuum pads, each of the vacuum pads being coupled to a corresponding one of the spring plungers; and
a plurality of ball joints respectively located between the spring plungers and the vacuum pads.

3. The skin attachment system of claim 2, wherein the vacuum module further comprises a skin detection sensor mounted on the vacuum manifold.

4. The skin attachment system of claim 3, further comprising a vacuum generator mounted on the robot body,
wherein the vacuum generator is fluidly connected to the vacuum manifold.

5. The skin attachment system of claim 1, wherein each of the vacuum pads is formed of a wrinkle pad.

6. The skin attachment system of claim 1, further comprising a skin storage unit configured to provide the skin to the skin adsorption unit,
wherein the skin storage unit comprises:
a guide part configured to allow the skin to be loaded therein;
a storage located at a lower end of the guide part;
a skin plate located between the guide part and the storage;
a first position sensor located at a lower end of the skin plate, the first position sensor being disposed to face the skin; and
a second position sensor mounted on at least one of opposite upper side surfaces of the guide part.

7. The skin attachment system of claim 6, wherein the skin storage unit further comprises:
a ball screw coupled to the skin plate; and
a motor coupled to the ball screw and configured to drive the ball screw,
wherein the ball screw moves the skin plate upwards or downwards.

8. The skin attachment system of claim 7, wherein the controller is configured to, upon receiving a position signal of the skin from the second position sensor and determining that the skin is not located at a predetermined position of the skin storage unit, control the ball screw such that the skin is located at a set position.

9. The skin attachment system of claim 6, wherein the skin storage unit further comprises a moving cylinder located to face the guide part, the moving cylinder being configured to move the guide part along an upper surface of the storage.

10. The skin attachment system of claim 9, wherein the controller is configured to, upon receiving information on presence or absence of the skin loaded in the guide part from the first position sensor and determining that the skin in not loaded in the guide part, control the moving cylinder such that the guide part is located at a set position.

11. The skin attachment system of claim 2, wherein the controller is configured to control a vacuum level of each of the vacuum pads and/or a length of each of the spring plungers according to the curvature value of the panel.

12. The skin attachment system of claim 2, further comprising an image detector configured to inspect an attachment state of the skin attached to the vacuum pads.

13. A vehicle skin attachment assembly comprising:
a robot; and
the skin attachment system of claim 1 for attaching a skin to the vehicle.

14. A skin attachment control method for attaching a skin to a vehicle, the skin attachment control method comprising:
determining, by a controller, whether a skin storage unit is in a normal state;
determining, by the controller, whether a skin adsorption unit is in a normal state when the skin storage unit is in the normal state;
applying, by the controller, a sealer to a jig when the skin adsorption unit is in the normal state;
attaching, by the controller, a skin corresponding to a position of the applied sealer; and
monitoring, by the controller, whether the skin is attached to a correct position of the sealer.

15. The skin attachment control method of claim 14, wherein determining whether the skin storage unit is in the normal state comprises:
receiving, by the controller, information on presence or absence of the skin in the skin storage unit from a first position sensor and determining, by the controller, whether the skin is loaded in the skin storage unit; and
receiving, by the controller, information on whether the skin is present at a predetermined position of the skin storage unit from a second position sensor when the skin is loaded in the skin storage unit and determining, by the controller, whether the skin is located in the predetermined position of the storage unit.

16. The skin attachment control method of claim 14, wherein determining whether the skin adsorption unit is in the normal state when the skin storage unit is in the normal state comprises:
adsorbing the skin to the skin adsorption unit; and
receiving, by the controller, a skin position from a skin detection sensor when the skin is adsorbed to the skin adsorption unit, determining, by the controller, whether the skin is adsorbed to a predetermined position of the skin adsorption unit, receiving, by the controller, a vacuum level of a vacuum manifold from a vacuum measurement sensor, and determining, by the controller, whether the vacuum level is equal to or higher than a set vacuum level.

17. The skin attachment control method of claim 15, wherein determining whether the skin is located in the predetermined position of the storage unit comprises:
moving, by the controller, a plate upwards when the skin is out of the predetermined position of the storage unit;
determining, by the controller, whether a height of the plate is equal to or higher than a set reference value after the plate is moved upwards; and
issuing a skin replenishment notification when the height of the plate is equal to or higher than the set reference value in the determination of whether the height of the plate is equal to or higher than the set reference value.

18. The skin attachment control method of claim 14, wherein applying the sealer to the jig when the skin adsorption unit is in the normal state comprises:
moving, by the controller, an application unit to the jig; and
applying the sealer corresponding to a position set in the controller.

19. The skin attachment control method of claim 14, wherein attaching the skin corresponding to the position of the applied sealer comprises:
receiving, by the controller, the position of the applied sealer from a camera sensor and moving, by the controller, the skin adsorption unit corresponding to the position of the applied sealer;
receiving, by the controller, the position of the applied sealer from the camera sensor and determining, by the controller, whether the skin adsorption unit is located above the applied sealer;
releasing, by the controller, vacuum of the skin adsorption unit when the skin adsorption unit is located above the sealer and attaching, by the controller, the skin to the applied sealer; and
attaching, by the controller, the skin to the applied sealer and moving, by the controller, the skin adsorption unit to an original position thereof.

20. The skin attachment control method of claim 19, wherein receiving the position of the applied sealer from the camera sensor and determining, by the controller, whether the skin adsorption unit is located above the applied sealer comprises
relocating, by the controller, the skin adsorption unit above the applied sealer when the skin adsorption unit is not located above the applied sealer.
